(19) United States
(12) Patent Application Publication
(10) Pub. No.: US 2016/0343073 A1
(43) Pub. Date: Nov. 24, 2016

(54) SYSTEMS TO MAKE AVAILABLE A SYNTHETIC INTEREST RATE AND RELATED METHODS

(71) Applicant: Pacific Coast Bankers' Bank, Walnut Creek, CA (US)

(72) Inventors: Daniel Forrest Wheeler, San Francisco, CA (US); Steven John Baca, San Leandro, CA (US); Allen James Sztukowski, Concord, CA (US); Dennis John Trompeter, Kenilworth, IL (US)

(73) Assignee: Pacific Coast Bankers' Bank, Walnut Creek, CA (US)

(21) Appl. No.: 14/741,333

(22) Filed: Jun. 16, 2015

Related U.S. Application Data
(60) Provisional application No. 62/165,831, filed on May 22, 2015.

(51) Int. Cl. G06Q 40/02

(52) U.S. Cl. CPC G06Q 40/025

(57) ABSTRACT

Some embodiments include a method of making available a synthetic fixed interest rate to a borrower under a loan and a variable interest rate to a lender of the loan. The method includes generating a settlement notice and sending the settlement notice. The settlement notice includes one of a notice of a first interest payment amount or a notice of a second interest payment amount. Further, when the settlement notice comprises the notice of the first interest payment amount, the method includes sending the first interest payment amount, and when the settlement notice comprises the notice of the second interest payment amount, the method includes receiving the second interest payment amount. Further still, the method includes receiving from the borrower a shared security interest in collateral securing the loan, and the shared security interest is shared with the lender. Other embodiments of related methods and systems are also provided.

### CROSS-REFERENCE TO RELATED APPLICATIONS

This application claims the benefit of U.S. Provisional Patent Application No. 62/165,831, filed May 22, 2015. U.S. Provisional Patent Application No. 62/165,831 is incorporated herein by reference in its entirety.

### TECHNICAL FIELD

This disclosure relates generally to systems to make available synthetic interest rates to borrowers under loans made by lenders, and relates more particularly to systems to make available synthetic interest rates to borrowers under loans made by credit union lenders and to related methods.

### BACKGROUND

Although the specific terms of a loan agreement may vary, in most loan agreements, generally speaking, a lender loans an initial principal amount to a borrower for a period of time (i.e., for a term of the loan), and the borrower agrees to repay the initial principal amount to the lender at an interest rate. Under some loan agreements (i.e., fixed rate loan agreements), the interest rate may be fixed while under other loan agreements (i.e., variable rate loan agreements), the interest rate may vary (i.e., float), such as, for example, according to a market-driven interest rate. Under certain circumstances, when a loan agreement has a fixed interest rate, a borrower or a lender may determine a variable interest rate is more desirable, or when a loan agreement has a variable interest rate, a borrower or lender may determine a fixed interest is more desirable. Under these circumstances, the borrower or lender may desire to enter into an interest rate swap agreement with a swap provider to change the type of interest rate paid or received. An interest rate swap agreement is a contractual agreement (classified as derivative) in which two contract counterparties (e.g., the borrower or lender, and the swap provider) agree to exchange financial payments (e.g., interest rates). In one type of interest rate swap agreement, referred to in commercial banking as a plain vanilla interest rate swap agreement, the two contract counterparties agree to exchange a fixed interest rate payment for a variable interest rate payment, or vice versa, with both the fixed interest rate payment and the variable interest rate payment being based on an agreed notional amount.

For example, a lender may desire to receive a variable interest rate from a borrower under a loan to ensure the lender receives the benefit of rising interest rates. Such an arrangement may be particularly desirable where the lender is a credit union lender. Generally, the deposits of a credit union provide the credit union's primary source of funding and increase in cost as prevailing interest rates increase. Regardless of the type of lender involved, because a variable interest rate generally rises when prevailing rates rise, a lender can mitigate the interest rate risk of rising deposit rates making fixed rate loans less profitable (or even a loss) by having variable rate loans or by swapping the fixed rate on its loans for a variable rate. Meanwhile, a borrower may desire to receive a fixed rate loan, such as, for example, to prevent her borrowing costs from rising. Under these circumstances, the borrower can enter into a variable rate loan agreement with the lender and enter into an interest rate swap agreement with a swap provider to convert the variable interest rate into a fixed interest rate. Accordingly, the borrower can provide a fixed interest rate to the swap provider in exchange for a variable interest rate, and the borrower can provide the variable interest rate to the lender. The outcome of the borrower entering into the variable rate loan agreement with the lender and the interest rate swap agreement with the swap provider is that the lender receives the benefits of a variable rate loan and the borrower receives the benefits of a fixed rate. Accordingly, a synthetic interest rate can refer to an interest rate a party is responsible to pay, net of a loan obligation and an interest rate swap agreement with a swap provider.

However, the amounts a party pays under an interest rate swap agreement is usually a function of movements in market interest rates over which the party has no control. As a result, interest rate swaps are classified as a “derivative” and are heavily regulated by the government. Accordingly, such government regulation, as well as various other obstacles, may make it difficult or impossible for a borrower and/or lender to reap the benefits of an interest rate swap agreement, such as, for example, where the loan agreement is between a borrower and a credit union lender. In particular, there are at least several obstacles that may make it difficult or impossible for a borrower and a credit union lender to reap the potential benefits of an interest rate swap agreement. These obstacles may include a regulatory prohibition on a credit union entering into interest rate swap agreements with borrowers or, in many cases, a prohibition on entering into any swaps at all, a document complexity of an interest rate swap agreement, a collateral requirement for an interest rate swap agreement, and the accounting and regulatory complexity of an interest rate swap agreement.

Regarding the document complexity of an interest rate swap agreement, the standard documents developed by the International Swap Dealers Association (“ISDA”) for interest rate swap agreements are numerous, lengthy, and difficult to understand, making these standard documents impracticable for use by parties other than large banks and sophisticated companies. For example, these documents may include a Master Agreement, a Schedule, a Credit Support Annex, and numerous Protocol documents. The complexity of these standard documents results at least in part because the transactions that these standard documents evidence require compliance with complex accounting and regulatory rules applying to a range of derivatives, including interest rate swap agreements.

Regarding the collateral requirement for an interest rate swap agreement, before entering into an interest rate swap agreement with a borrower or lender, a swap provider requires the borrower or lender to pledge collateral to protect the swap provider from losses under the interest rate swap agreement where the fault is attributable to the borrower and/or lender. In almost all cases, the swap provider requires its counterparty to separately pledge collateral in the form of cash or securities. However, borrowers and lenders other than large banks and sophisticated companies frequently lack the necessary resources to make such a pledge of collateral.

Meanwhile, in many examples, the accounting and regulatory complexity of an interest rate swap agreement can be the most serious obstacle preventing a borrower and a credit union lender from reaping the potential benefits of an interest rate swap agreement. For example, any lender that is a party to an interest rate swap must value and account for its future liability under the interest rate swap agreement in compliance with complex accounting rules, such as, for example, Financial Accounting Standard Board Accounting Standards Codification Topic 815: Derivatives and Hedging. Entities other than large banks and sophisticated companies generally lack sufficient training and equipment to satisfy compliance with these complex accounting rules. Likewise, a volume of the regulations governing interest rate swap agreements alone makes complying with such regulations difficult and expensive. For example, compliance often requires that a lender hire specialized experts, develop new policies and procedures, invest in compliance monitoring systems, and/or obtain significant additional training for directors, management, and other personnel. As a result, as of May 2015, fewer than five percent of United States banks having an amount of assets less than one billion United States dollars engage in interest rate swap agreements. Far fewer United States credit unions engage in interest rate swaps than do banks, and no United States credit unions enter into swaps with their borrowers. These accounting and regulatory obstacles as well as the foregoing obstacles of document complexity and collateral requirements apply to any lenders, but credit union lenders are required to comply with additional regulatory and accounting burdens.

For example, credit union lenders were first authorized to enter into interest rate swap agreements only as of March 2014, and conventionally, only credit union lenders that qualify for authority to engage in derivatives activities are able to enter into interest rate swap agreements. As of May 2015, in order to qualify for authority to engage in derivatives activities, a credit union lender must have a rating of three or better under the Camels rating system for banks and credit unions, and must have an amount of assets of at least 250 million United States dollars. Many credit union lenders are unable to satisfy at least one of these conditions. Further, even credit union lenders satisfying these minimum requirements can still be denied qualification for authority to engage in derivatives activities by state and/or federal regulators.

Meanwhile, even those credit union lenders that do qualify for authority to engage in derivatives activities are limited as to the types of interest rate swap agreements into which those credit union lenders are permitted to enter, and as of May 2015, the terms of those interest rate swap agreements are tightly restricted under Title 12, Sections 703.1 through 703.20 of the United States Code of Federal Regulations and under related provisions of National Credit Union Administration (“NCUA”) law and regulations. Further, as of May 2015, Title 12, Section 703.104(a)(1) of the United States Code of Federal Regulations permits credit union lenders to enter into interest rate swap agreements with only Commodity Futures Trading Commission (“CFTC”) registered swap providers. Meanwhile, credit union lenders are prohibited from entering into interest rate swap agreements with borrowers.

Accordingly, there is a need for systems and methods permitting a borrower and a credit union lender to reap the benefits of an interest rate swap agreement.

### BRIEF DESCRIPTION OF THE DRAWINGS

To facilitate further description of the embodiments, the following drawings are provided in which:

FIG. 1 illustrates a front elevational view of an exemplary computer system that is suitable to implement at least part of a central computer system, at least part of one or more borrower computer systems, at least part of one or more lender computer systems, and/or at least part of one or more third party computer systems of the system of FIG. 3, and/or to implement at least part of one or more of the activities of the method of FIG. 6 or one or more other methods described herein;

FIG. 2 illustrates a representative block diagram of exemplary elements included on the circuit boards inside a chassis of the computer system of FIG. 1;

FIG. 3 illustrates a representative block diagram of a system, according to an embodiment;

FIG. 4 illustrates a representative block diagram of a central computer system of the system of FIG. 3, according to the embodiment of FIG. 3;

FIG. 5 illustrates a representative block diagram of one or more databases of the system of FIG. 3, according to the embodiment of FIG. 3;

FIG. 6 illustrates a flow chart for a method, according to an embodiment;

FIG. 7 illustrates an exemplary activity of sending a settlement notice, according to the embodiment of FIG. 6;

FIG. 8 illustrates an exemplary activity of sending a first interest payment amount, according to the embodiment of FIG. 6; and

FIG. 9 illustrates an exemplary activity of receiving a second interest payment amount, according to the embodiment of FIG. 6.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

When the term “amount” is used abstractly herein (i.e., without expressly referencing an amount of something specific), the term ‘amount” may be understood generally to refer to an amount of currency, such as, for example, United States currency. This short form is used as a matter of convenience and should not necessarily be construed as limiting. In other embodiments, when the term “amount” is used abstractly herein, the term “amount” may refer to an amount of any suitable medium of exchange, including, for example, a commodity.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Some embodiments include a method of making available a synthetic fixed interest rate to a borrower under a loan and a variable interest rate to a lender of the loan. The method can comprise: executing one or more first computer instructions configured to generate a settlement notice, the settlement notice comprising one of a notice of a first interest payment amount or a notice of a second interest payment amount; executing one or more second computer instructions configured to send the settlement notice; when the settlement notice comprises the notice of the first interest payment amount, sending the first interest payment amount; when the settlement notice comprises the notice of the second interest payment amount, receiving the second interest payment amount; and receiving from the borrower a shared security interest in collateral securing the loan, the shared security interest being shared with the lender. In these embodiments, the loan can comprise a variable rate loan, the loan can be made by the lender to the borrower, and the variable interest rate on the loan can be synthetically fixed by entering into an interest rate swap. Meanwhile, the first interest payment amount can be calculated with reference to a difference of a current note interest rate less a swap interest rate and with reference to a current notional amount corresponding to a current principal amount of the loan, and the second interest payment amount can be calculated with reference to a difference of the swap interest rate less the current note interest rate and with reference to the current notional amount. The current note interest rate can comprise the variable interest rate of the loan, the swap interest rate can comprise the synthetic fixed interest rate, and the lender can comprise a credit union lender. Further, the settlement notice can comprise the notice of the first interest payment amount when the difference of the current note interest rate less the swap interest rate is greater than zero, and the settlement notice can comprise the notice of the second interest payment amount when the difference of the swap interest rate less the current note interest rate is greater than zero. Further still, the one or more first computer instructions and the one or more second computer instructions can be configured to run at one or more processing modules and configured to be stored at one or more non-transitory memory storage modules.

Further embodiments include a system operable to make available a synthetic fixed interest rate to a borrower under a loan and a variable interest rate to a lender of the loan. The system comprises an input device, a display device, one or more processing modules, and one or more non-transitory memory storage modules storing computer instructions configured to run on the one or more processing modules. The processing module(s) can perform the acts of: generating a settlement notice, the settlement notice comprising one of a notice of a first interest payment amount or a notice of a second interest payment amount; sending the settlement notice; when the settlement notice comprises the notice of the first interest payment amount, sending the first interest payment amount; and when the settlement notice comprises the notice of the second interest payment amount, receiving the second interest payment amount. An operator of the system and the lender can hold a shared security interest in at least part of collateral securing the loan. In these embodiments, the loan can comprise a variable rate loan, the loan can be made by the lender to the borrower, and the variable interest rate on the loan can be synthetically fixed by entering into an interest rate swap. Meanwhile, the first interest payment amount can be calculated with reference to a difference of a current note interest rate less a swap interest rate and with reference to a current notional amount corresponding to a current principal amount of the loan, and the second interest payment amount can be calculated with reference to a difference of the swap interest rate less the current note interest rate and with reference to the current notional amount. The current note interest rate can comprise the variable interest rate of the loan, the swap interest rate can comprise the synthetic fixed interest rate, and the lender can comprise a credit union lender. Further, the settlement notice can comprise the notice of the first interest payment amount when the difference of the current note interest rate less the swap interest rate is greater than zero, and the settlement notice can comprise the notice of the second interest payment amount when the difference of the swap interest rate less the current note interest rate is greater than zero. Further still, the input device and the display device can be configured to permit the operator to manage the one or more processing modules and the one or more non-transitory memory storage modules.

Other embodiments include a method of making available a synthetic fixed interest rate to a borrower under a loan while receiving a variable interest rate under the loan as a credit union lender. The method can comprise: making a loan to the borrower; granting to a swap provider a priority right of recovery in collateral securing the loan; executing one or more first computer instructions configured to receive a settlement notice from the swap provider, the settlement notice comprising one of a notice of a first interest payment amount or a notice of a second interest payment amount; and executing one or more second computer instructions configured to transform the variable interest rate to the synthetic fixed interest rate made available to the borrower. Meanwhile, the executing the one or more second computer instructions can comprise: when the settlement notice comprises the notice of the first interest payment amount, executing one or more third computer instructions configured to receive the first payment amount from the swap provider; and when the settlement notice comprises the notice of the second interest payment amount, executing one or more fourth computer instructions configured to send the second interest payment amount to the swap provider. Further, the borrower can receive the synthetic fixed interest rate by entering into an interest rate swap with the swap provider. Meanwhile, the first interest payment amount can be calculated with reference to a difference of a current note interest rate less a swap interest rate and with reference to a current notional amount corresponding to a current principal amount of the loan, and the second interest payment amount can be calculated with reference to a difference of the swap interest rate less the current note interest rate and with reference to the current notional amount. The current note interest rate can comprise the variable interest rate of the loan, and the swap interest rate can comprise the synthetic fixed interest rate. Further, the settlement notice can comprise the notice of the first interest payment amount when the difference of the current note interest rate less the swap interest rate is greater than zero, and the settlement notice can comprise the notice of the second interest payment amount when the difference of the swap interest rate less the current note interest rate is greater than zero. Further still, the one or more first computer instructions, the one or more second computer instructions, the one or more third computer instructions, and the one or more fourth computer instructions can be configured to run at one or more processing modules and configured to be stored at one or more non-transitory memory storage modules.

Some embodiments include a method of making available a synthetic variable interest rate to a borrower under a loan and a fixed interest rate to a lender of the loan. The method can comprise: executing one or more first computer instructions configured to generate a settlement notice, the settlement notice comprising one of a notice of a first interest payment amount or a notice of a second interest payment amount; executing one or more second computer instructions configured to send the settlement notice; when the settlement notice comprises the notice of the first interest payment amount, sending the first interest payment amount; when the settlement notice comprises the notice of the second interest payment amount, receiving the second interest payment amount; and receiving from the borrower a shared security interest in collateral securing the loan, the shared security interest being shared with the lender. In these embodiments, the loan can comprise a fixed rate loan, the loan can be made by the lender to the borrower, and the fixed interest rate on the loan can be synthetically varied by entering into an interest rate swap. Meanwhile, the first interest payment amount can be calculated with reference to a difference of a current note interest rate less a swap interest rate and with reference to a current notional amount corresponding to a current principal amount of the loan, and the second interest payment amount can be calculated with reference to a difference of the swap interest rate less the current note interest rate and with reference to the current notional amount. The current note interest rate can comprise the fixed interest rate of the loan, the swap interest rate can comprise the synthetic variable interest rate, and the lender can comprise a credit union lender. Further, the settlement notice can comprise the notice of the first interest payment amount when the difference of the current note interest rate less the swap interest rate is greater than zero, and the settlement notice can comprise the notice of the second interest payment amount when the difference of the swap interest rate less the current note interest rate is greater than zero. Further still, the one or more first computer instructions and the one or more second computer instructions can be configured to run at one or more processing modules and configured to be stored at one or more non-transitory memory storage modules.

Further embodiments include a system operable to make available a synthetic variable interest rate to a borrower under a loan and a fixed interest rate to a lender of the loan. The system comprises an input device, a display device, one or more processing modules, and one or more non-transitory memory storage modules storing computer instructions configured to run on the one or more processing modules. The processing module(s) can perform the acts of: generating a settlement notice, the settlement notice comprising one of a notice of a first interest payment amount or a notice of a second interest payment amount; sending the settlement notice; when the settlement notice comprises the notice of the first interest payment amount, sending the first interest payment amount; and when the settlement notice comprises the notice of the second interest payment amount, receiving the second interest payment amount. An operator of the system and the lender can hold a shared security interest in at least part of collateral securing the loan. In these embodiments, the loan can comprise a fixed rate loan, the loan can be made by the lender to the borrower, and the fixed interest rate on the loan can be synthetically varied by entering into an interest rate swap. Meanwhile, the first interest payment amount can be calculated with reference to a difference of a current note interest rate less a swap interest rate and with reference to a current notional amount corresponding to a current principal amount of the loan, and the second interest payment amount can be calculated with reference to a difference of the swap interest rate less the current note interest rate and with reference to the current notional amount. The current note interest rate can comprise the fixed interest rate of the loan, the swap interest rate can comprise the synthetic variable interest rate, and the lender can comprise a credit union lender. Further, the settlement notice can comprise the notice of the first interest payment amount when the difference of the current note interest rate less the swap interest rate is greater than zero, and the settlement notice can comprise the notice of the second interest payment amount when the difference of the swap interest rate less the current note interest rate is greater than zero. Further still, the input device and the display device can be configured to permit the operator to manage the one or more processing modules and the one or more non-transitory memory storage modules.

Other embodiments include a method of making available a synthetic variable interest rate to a borrower under a loan while receiving a fixed interest rate under the loan as a credit union lender. The method can comprise: making a loan to the borrower; granting to a swap provider a priority right of recovery in collateral securing the loan; executing one or more first computer instructions configured to receive a settlement notice from the swap provider, the settlement notice comprising one of a notice of a first interest payment amount or a notice of a second interest payment amount; and executing one or more second computer instructions configured to transform the fixed interest rate to the synthetic variable interest rate made available to the borrower. Meanwhile, the executing the one or more second computer instructions can comprise: when the settlement notice comprises the notice of the first interest payment amount, executing one or more third computer instructions configured to receive the first payment amount from the swap provider; and when the settlement notice comprises the notice of the second interest payment amount, executing one or more fourth computer instructions configured to send the second interest payment amount to the swap provider. Further, the borrower can receive the synthetic variable interest rate by entering into an interest rate swap with the swap provider. Meanwhile, the first interest payment amount can be calculated with reference to a difference of a current note interest rate less a swap interest rate and with reference to a current notional amount corresponding to a current principal amount of the loan, and the second interest payment amount can be calculated with reference to a difference of the swap interest rate less the current note interest rate and with reference to the current notional amount. The current note interest rate can comprise the fixed interest rate of the loan, and the swap interest rate can comprise the synthetic variable interest rate. Further, the settlement notice can comprise the notice of the first interest payment amount when the difference of the current note interest rate less the swap interest rate is greater than zero, and the settlement notice can comprise the notice of the second interest payment amount when the difference of the swap interest rate less the current note interest rate is greater than zero. Further still, the one or more first computer instructions, the one or more second computer instructions, the one or more third computer instructions, and the one or more fourth computer instructions can be configured to run at one or more processing modules and configured to be stored at one or more non-transitory memory storage modules.

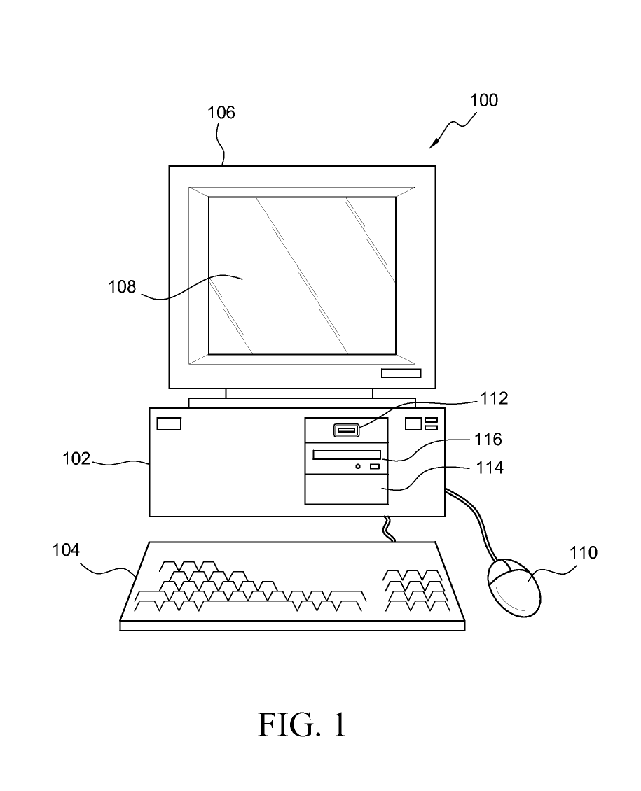

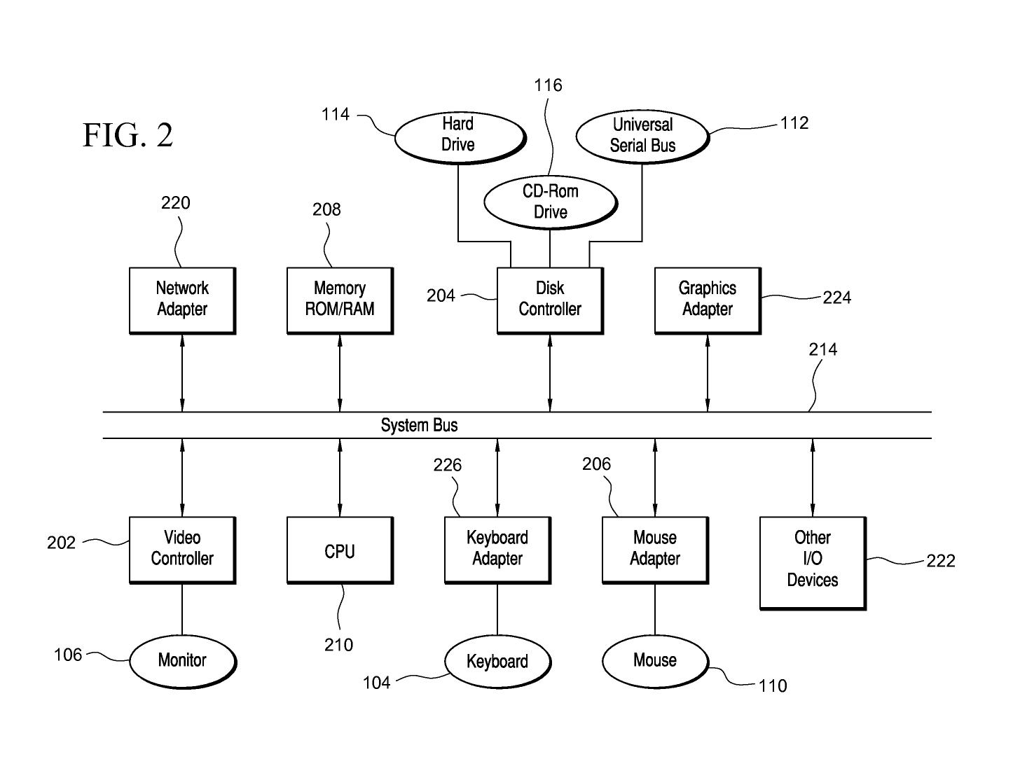

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a refreshing monitor 106, a keyboard 104, and/or a mouse 110, etc.) can also be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) volatile (e.g., transitory) memory, such as, for example, read only memory (ROM) and/or (ii) non-volatile (e.g., non-transitory) memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage module(s) of the various embodiments disclosed herein can comprise memory storage unit 208, an external memory storage drive (not shown), such as, for example, a USB-equipped electronic memory storage drive coupled to universal serial bus (USB) port 112 (FIGS. 1 & 2), hard drive 114 (FIGS. 1 & 2), CD-ROM and/or DVD drive 116 (FIGS. 1 & 2), a floppy disk drive (not shown), an optical disc (not shown), a magneto-optical disc (now shown), magnetic tape (not shown), etc. Further, non-volatile or non-transitory memory storage module(s) refer to the portions of the memory storage module(s) that are non-volatile (e.g., non-transitory) memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise (i) Microsoft® Windows® operating system (OS) by Microsoft Corp. of Redmond, Wash., United States of America, (ii) Mac® OS by Apple Inc. of Cupertino, Calif., United States of America, (iii) UNIX® OS, and (iv) Linux® OS. Further exemplary operating systems can comprise (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States of America, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1 & 2) and mouse 110 (FIGS. 1 & 2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1 & 2) to display images on a screen 108 (FIG. 1) of computer system 100 (FIG. 1). Disk controller 204 can control hard drive 114 (FIGS. 1 & 2), USB port 112 (FIGS. 1 & 2), and CD-ROM drive 116 (FIGS. 1 & 2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, in many examples, system 100 can have a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smart phone. In certain additional embodiments, computer system 100 may comprise an embedded system.

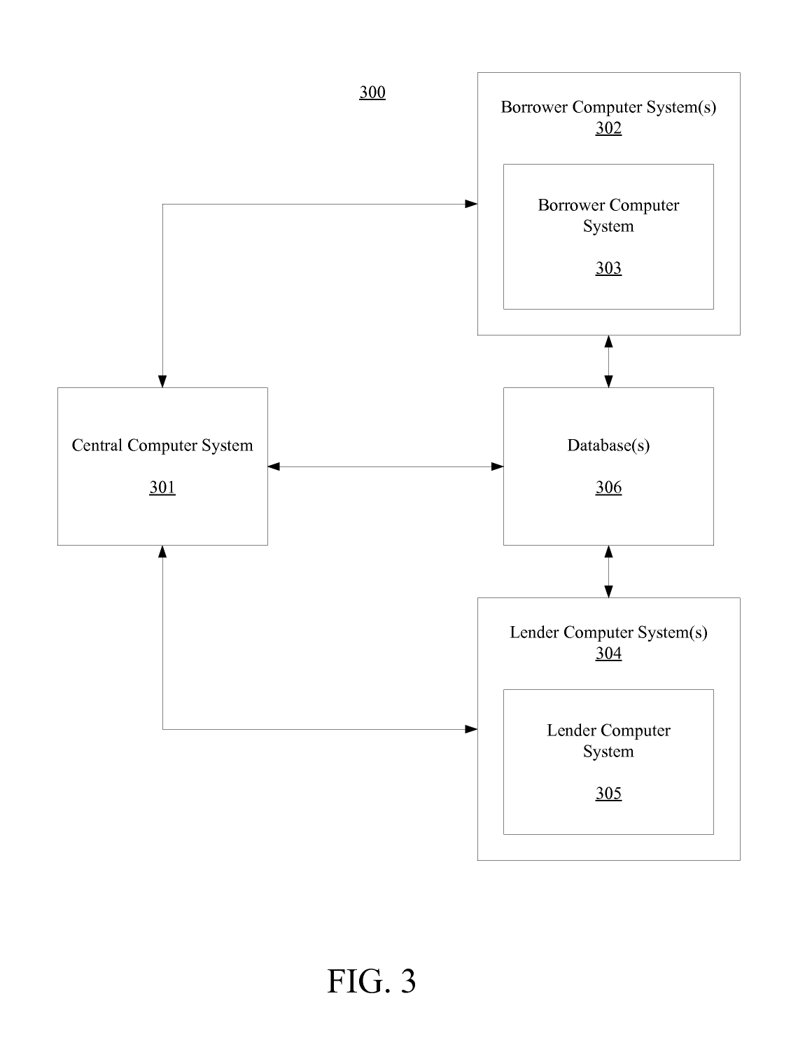

Skipping ahead now in the drawings, FIG. 3 illustrates a representative block diagram of a system 300, according to an embodiment. System 300 is merely exemplary and embodiments of the system are not limited to the embodiments presented herein. System 300 can be employed in many different embodiments or examples not specifically depicted or described herein. In some embodiments, certain elements or modules of system 300 can perform various methods and/or activities of those methods. In these or other embodiments, the methods and/or the activities of the methods can be performed by other suitable elements or modules of system 300.

System 300 can permit a borrower and a lender to reap the benefits of an interest rate swap agreement. For example, system 300 can be operable to make available a synthetic fixed interest rate to a borrower under a loan and make available a variable interest rate to a lender of the loan; and/or system 300 can be operable to make available a synthetic variable interest rate to a borrower under a loan and make available a fixed interest rate to a lender of the loan. When system 300 is operable to make available a synthetic fixed interest rate to the borrower under a loan and make available a variable interest rate to a lender of the loan, the loan can comprise a variable rate loan made by the lender to the borrower; in these embodiments, the variable interest rate on the loan can be synthetically fixed as a result of a swap provider entering into an interest rate swap with the borrower, and in some embodiments, the swap provider can be an operator and/or administrator of system 300. Meanwhile, when system 300 is operable to make available a synthetic variable interest rate to a borrower under a loan and make available a fixed interest rate to a lender of the loan, the loan can comprise a fixed rate loan made by the lender to the borrower; in these embodiments, the fixed interest rate on the loan can be synthetically varied as a result of a swap provider entering into an interest rate swap with the borrower, and in some embodiments, the swap provider can be an operator and/or administrator of system 300. In these or other embodiments, system 300 can be operable to transform a synthetic fixed interest rate made available to a borrower under a loan into a variable interest rate due to a lender of the loan, and vice versa; and/or system 300 can be operable to transform a synthetic variable interest rate made available to a borrower under a loan to a fixed interest rate due to a lender of the loan, and vice versa.

Advantageously, in these or other embodiments, the lender can comprise a credit union lender, and in many embodiments, can comprise any credit union lender. Indeed, in further embodiments, the lender can comprise any lender. Further, in these or other embodiments, system 300 can overcome one or more or all of the obstacles (e.g., regulatory prohibitions on a credit union lender entering into a swap with a borrower, a document complexity of an interest rate swap agreement, a collateral requirement for an interest rate swap agreement, an accounting and regulatory complexity of an interest rate swap agreement, etc.) that may prevent a borrower and/or a lender from reaping the benefits of an interest rate swap agreement, the manner of which is explained in greater detail below.

Specifically, under system 300, the lender partners with a swap provider, and the swap provider enters into an interest rate swap agreement with the borrower. For example, in these embodiments, the lender can partner with the swap provider by entering into a servicing and intercreditor agreement with the swap provider, and the swap provider can enter into a rate protection agreement (i.e., the interest rate swap agreement) with the borrower.

With respect to credit union lenders in particular, while the NCUA has published no express authority permitting a credit union lender, whether or not having authority to engage in derivatives activities, to partner with a swap provider where the swap provider enters into the interest rate swap agreement with the borrower, system 300 makes such an arrangement possible, despite numerous regulations appearing to make such an arrangement impossible. For example, as of May 2015, Title 12, Section 1757(5)(A)(viii) of the United States Code and Title 12, Section 701.21 of the United States Code of Federal Regulations prohibits borrowers of credit union lenders from paying prepayment penalties in connection with credit union loans. However, in many examples, interest rate swap agreements include a swap termination fee due and payable upon early termination of the interest rate swap agreement, which may occur when a loan is prepaid or defaulted. Meanwhile, as of May 2015, Title 12, Section 723.7 of the United States Code of Federal Regulations requires that all loan agreements made between borrowers and credit union lenders be secured by collateral such that the maximum loan-to-value (LTV) ratio does not exceed 80 percent. The NCUA has published nothing indicating that the collateral for the loan may also secure the interest rate swap agreement, nor has the NCUA indicated how the 80 percent LTV ratio would be satisfied where the collateral for the loan also secures an interest rate swap agreement.

Nonetheless, as explained in greater detail below in context, in many embodiments, any swap termination fee required under system 300 does not qualify as a legally prohibited penalty, and system 300 ensures that a LTV ratio of any collateral securing a loan agreement and an interest rate swap agreement does not exceed a maximum LTV ratio permitted by law. As a result, under system 300, a credit union lender, whether or not having authority to engage in derivatives activities, can partner with a swap provider, and the swap provider can enter into an interest rate swap agreement with the borrower. Because the swap provider enters into the interest rate swap agreement with the borrower as opposed to the lender, the accounting and regulatory complexity obstacle directed to lenders generally, and to credit union lenders specifically, do not apply under system 300. As a result, system 300 can overcome or avoid the obstacle of accounting and regulatory complexity of an interest rate swap agreement directed to lenders generally and directed to credit union lenders specifically, and meanwhile, can satisfy less substantial accounting and regulatory issues directed to borrowers generally and directed to borrowers of credit union lenders specifically. In fact, in many examples, a lender partnering with a swap provider under system 300 does not exercise derivatives authority within a legal jurisdiction in which the loan is made and in which the interest rate swap is entered.

Meanwhile, because of the partnership between the lender and the swap provider, and because the swap provider enters into an interest rate swap agreement with the borrower, the documentation needed to effect the partnership (e.g., the servicing and intercreditor agreement) and to effect the interest rate swap agreement (e.g., the rate protection agreement) can be simplified into layman's terms and made considerably shorter in length compared to the standard documents developed by the ISDA for interest rate swap agreements. As a result, system 300 can overcome the obstacle of document complexity of an interest rate swap agreement directed to lenders generally and directed to credit union lenders specifically.

Further, under system 300, the swap provider and the lender are able to share a lien on the same collateral that secures the loan agreement between the borrower and the lender and the interest rate swap agreement between the borrower and the swap provider, the borrower is not required to post separate collateral for each of the loan agreement and the interest rate swap agreement. As a result, system 300 can overcome the obstacle of a collateral requirement of an interest rate swap agreement directed to lenders generally and directed to credit union lenders specifically.

Generally, therefore, system 300 can be implemented with hardware and/or software, as described herein. In some embodiments, at least part of the hardware and/or software can be conventional, while in these or other embodiments, part or all of the hardware and/or software can be customized (e.g., optimized) for implementing part or all of the functionality of system 300 described herein.

Specifically, system 300 can comprise a central computer system 301. In many embodiments, central computer system 301 can be similar or identical to computer system 100 (FIG. 1). Accordingly, central computer system 301 can comprise one or more processing modules and one or more memory storage modules (e.g., one or more non-transitory memory storage modules). In these or other embodiments, the processing module(s) and/or the memory storage module(s) can be similar or identical to the processing module(s) and/or memory storage module(s) (e.g., non-transitory memory storage modules) described above with respect to computer system 100 (FIG. 1). In some embodiments, central computer system 301 can comprise a single computer or server, but in many embodiments, central computer system 301 comprises a cluster or collection of computers or servers and/or a cloud of computers or servers. Meanwhile, central computer system 301 can comprise one or more input devices (e.g., one or more keyboards, one or more keypads, one or more pointing devices such as a computer mouse or computer mice, one or more touchscreen displays, etc.), and/or can comprise one or more display devices (e.g., one or more monitors, one or more touch screen displays, etc.). In these or other embodiments, one or more of the input device(s) can be similar or identical to keyboard 104 (FIG. 1) and/or a mouse 110 (FIG. 1). Further, one or more of the display device(s) can be similar or identical to refreshing monitor 106 (FIG. 1) and/or screen 108 (FIG. 1). The input device(s) and the display device(s) can be coupled to the processing module(s) and/or the memory storage module(s) of central computer system 301 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of central computer system 301. In a similar manner, the processing module(s) and the memory storage module(s) can be local and/or remote to each other.

In many embodiments, central computer system 301 is configured to communicate with one or more borrower computer systems 302 (e.g., a borrower computer system 303) of one or more borrowers; and/or central computer system 301 is configured to communicate with one or more lender computer systems 304 (e.g., a lender computer system 305) of one or more lenders. For example, the borrower(s) can interface (e.g., interact) with central computer system 301, and vice versa, via borrower computer system(s) 302; and/or the lender(s) can interface (e.g., interact) with central computer system 301, and vice versa, via lender computer system(s) 304. In some embodiments, system 300 can comprise borrower computer system(s) 302 and/or lender computer system(s) 304.

In many embodiments, central computer system 301 can refer to a back end of system 300 operated by an operator and/or administrator of system 300. In these or other embodiments, the operator and/or administrator of system 300 can manage central computer system 301, the processing module(s) of computer system 301, and/or the memory storage module(s) of computer system 301 using the input device(s) and/or display device(s) of central computer system 301. In some embodiments, as provided above, the operator and/or administrator of system 300 can comprise a swap provider.

Like central computer system 301, borrower computer system(s) 302 and/or lender computer system(s) 304 each can be similar or identical to computer system 100 (FIG. 1), and in many embodiments, each of borrower computer system(s) 302 can be similar or identical to each other, and/or each of lender computer system(s) 304 can be similar or identical to each other. Further, in some embodiments, each of lender computer system(s) 304 can be similar or identical to central computer system 301. At least part of central computer system 301 can be located remotely from borrower computer system(s) 302 and/or lender computer system(s) 304.

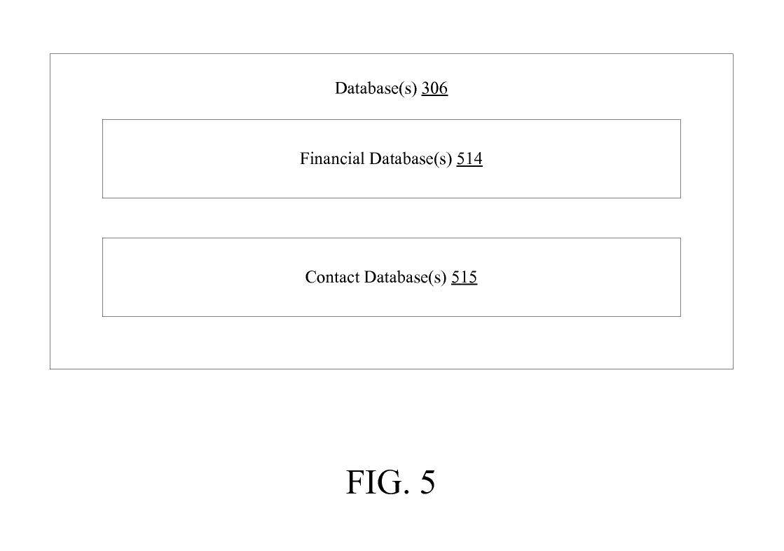

Meanwhile, in many embodiments, central computer system 301 also can be configured to communicate with one or more databases 306 (e.g., one or more financial databases 514 (FIG. 5), one or more contact databases 515 (FIG. 5), etc.). Database(s) 306 can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of database(s) 306, that particular database can be stored on a single memory storage module of the memory storage module(s) and/or the non-transitory memory storage module(s) storing database(s) 306 or it can be spread across multiple of the memory storage module(s) and/or non-transitory memory storage module(s) storing database(s) 306, depending on the size of the particular database and/or the storage capacity of the memory storage module(s) and/or non-transitory memory storage module(s).

In these or other embodiments, the memory storage module(s) of central computer system 301 can comprise some or all of the memory storage module(s) storing database(s) 306. In further embodiments, some of the memory storage module(s) storing database(s) 306 can be part of one or more of borrower computer system(s) 302, one or more of lender computer system(s) 304, and/or one or more third-party computer systems (i.e., other than central computer system 301, borrower computer system(s) 302, and/or lender computer system(s) 304), and in still further embodiments, all of the memory storage module(s) storing database(s) 306 can be part of one or more of borrower computer system(s) 302, one or more of lender computer system(s) 304, and/or one or more of the third-party computer system(s). Like central computer system 301, borrower computer system(s) 302, and/or lender computer system(s) 304, when applicable, each of the third-party computer system(s) can be similar or identical to computer system 100 (FIG. 1). Notably, the third-party computer systems are not shown at FIG. 3 in order to avoid unduly cluttering the illustration of FIG. 3, and database(s) 306 are illustrated at FIG. 3 apart from central computer system 301, borrower computer system(s) 302, and lender computer system(s) 304 to better illustrate that database(s) 306 can be stored at memory storage module(s) of central computer system 301, borrower computer system(s) 302, lender computer system(s) 304, and/or the third-party computer system(s), depending on the manner in which system 300 is implemented.

Database(s) 306 each can comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database and IBM DB2 Database.

Meanwhile, communication between central computer system 301, borrower computer system(s) 302, lender computer system(s) 304, the third-party computer system(s), and/or database(s) 306 can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3, IEEE 802.11, etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.

For convenience, the functionality of system 300 is described generally herein as it relates particularly to borrower computer system 303, lender computer system 305, a single borrower, and a single lender (e.g., a single credit union lender), but in many embodiments, the functionality of system 300 can be extended to each of borrower computer system(s) 302, lender computer system(s) 304, multiple borrowers, and/or multiple lenders (e.g., multiple credit union lenders).

Also for convenience, the functionality of system 300 is described generally herein with respect to a single transaction under a loan agreement of the borrower and the lender (i.e., with respect to a single payment under the loan agreement), but in many embodiments, the functionality of system 300 can be applied to multiple transactions (e.g., each transaction) under a loan agreement. In many examples, a loan agreement requires recurring (e.g., weekly, monthly, quarterly, semiannually, annually, etc.) transactions between the borrower and the lender over a term of the loan agreement. Accordingly, in many embodiments, the functionality of system 300 can be applied (e.g., repeated) for each of the transactions under a loan agreement. However, in further embodiments, the functionality of system 300 can be applied for fewer or more transactions than occur under a loan agreement, such as, for example, where a term of an interest rate swap agreement between the borrower and a swap provider is less than or greater than a term of the loan agreement.

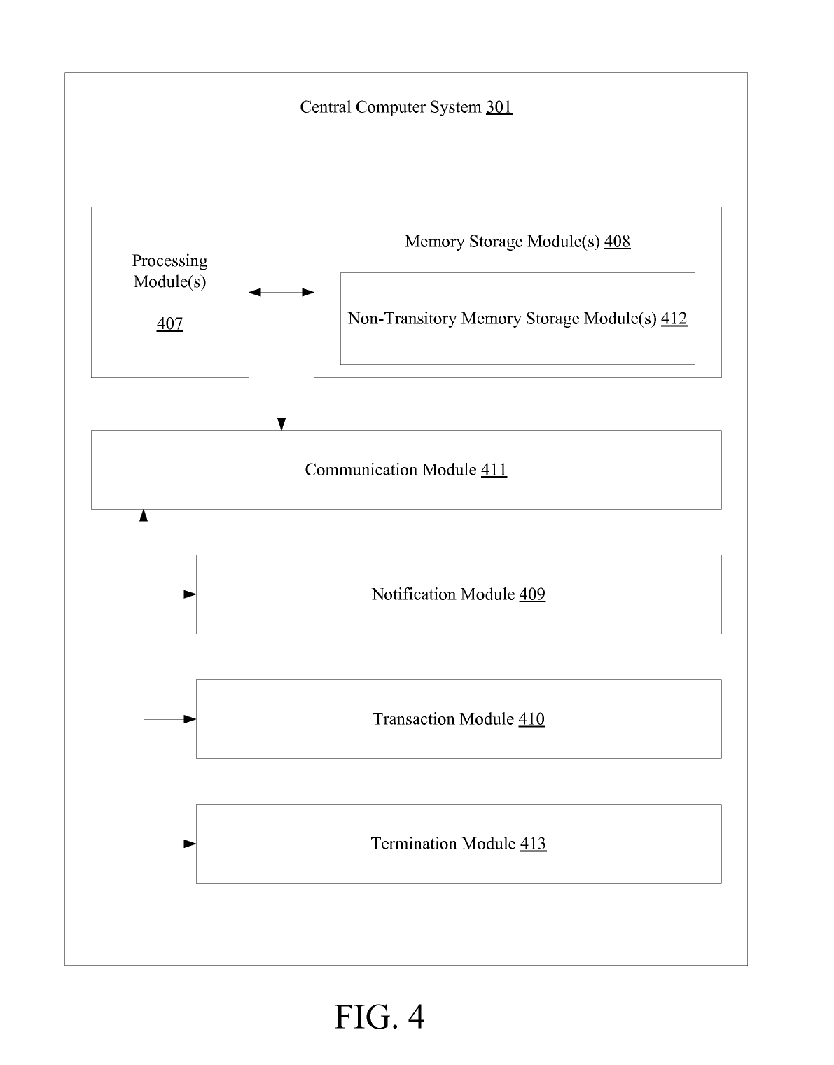

Turning ahead now in the drawings, FIG. 4 illustrates a representative block diagram of central computer system 301, according to the embodiment of FIG. 3; and FIG. 5 illustrates a representative block diagram of database(s) 306, according to the embodiment of FIG. 3.

Referring first to FIG. 4, in many embodiments, central computer system 301 can comprise one or more processing modules 407, one or more memory storage modules 408, a notification module 409, a transaction module 410, a communication module 411, and a termination module 413. Further, memory storage module(s) 408 can comprise one or more non-transitory memory storage modules 412. In some embodiments, part or all of at least one or more of notification module 409, transaction module 410, communication module 411, and/or termination module 413 can be part of at least one or more others of notification module 409, transaction module 410, communication module 411, termination module 413, and vice versa. In some embodiments, transaction module 410 can be omitted, such as, for example, where the functionality of transaction module 410 is performed manually.

Meanwhile, referring briefly to FIG. 5, database(s) 306 can comprise financial database(s) 514 and contact database(s) 515. In some embodiments, part or all of at least one or more of financial database(s) 514 or contact database(s) 515 can be part of the other of financial database(s) 514 and contact database(s) 515, and vice versa.

Returning now to FIG. 4, in many embodiments, processing module(s) 407 can be similar or identical to the processing module(s) described above with respect to computer system 100 (FIG. 1) and/or central computer system 301 (FIG. 3); memory storage module(s) 408 can be similar or identical to the memory storage module(s) described above with respect to computer system 100 (FIG. 1) and/or central computer system 301 (FIG. 3); and/or non-transitory memory storage module(s) 412 can be similar or identical to the non-transitory memory storage module(s) described above with respect to computer system 100 (FIG. 1) and/or central computer system 301 (FIG. 3). Further, notification module 409, transaction module 410, communication module 411, and termination module 413 can be implemented with hardware and/or software, as desirable. Although notification module 409, transaction module 410, communication module 411, and termination module 413 are shown at FIG. 4 as being separate from processing module(s) 407, memory storage module(s) 408, and/or non-transitory memory storage module(s) 412, in many embodiments, part or all of notification module 409, transaction module 410, communication module 411, and/or termination module 413 can be stored at memory storage module(s) 408 and/or non-transitory memory storage module(s) 412 and can be called and run at processing module(s) 407, such as, for example, when the part or all of notification module 409, transaction module 410, communication module 411, and/or termination module 413 are implemented as software. Still, in some embodiments, at least part of the functionality of transaction module 410 can be performed manually.

### Communication Module 411

Communications module 411 is operable to provide and manage communication between the various elements of central computer system 301 (e.g., processing module(s) 407, memory storage module(s) 408, non-transitory memory storage module(s) 412, notification module 409, transaction module 410, termination module 413, and/or communication module 411, etc.) and manage incoming and outgoing communications between central computer system 301 (FIG. 3) and borrower computer system(s) 302 of FIG. 3 (e.g., borrower computer system 303 (FIG. 3)), lender computer system(s) 304 of FIG. 3 (e.g., lender computer system 305 (FIG. 3)), and/or database(s) 306 (FIG. 3). Like the communications between central computer system 301 (FIG. 3), borrower computer system(s) 302 (FIG. 3), lender computer system(s) 304 (FIG. 3), the third party computer system(s), and/or database(s) 306 (FIG. 3), communication module 411 can be implemented using any suitable manner of wired and/or wireless communication, and/or using any one or any combination of wired and/or wireless communication network topologies and/or protocols, as described above with respect to the central computer system 301 (FIG. 3), borrower computer system(s) 302 (FIG. 3), lender computer system(s) 304 (FIG. 3), the third party computer system(s), and/or database(s) 306 (FIG. 3). In many embodiments, communication module 411 can be part of hardware and/or software implemented for communications between central computer system 301 (FIG. 3), borrower computer system(s) 302 (FIG. 3), lender computer system(s) 304 (FIG. 3), the third party computer system(s), and/or database(s) 306 (FIG. 3). For example, as applicable, communication module 411 can permit processing module(s) 404 to call (i) software (e.g., at least part of notification module 409, transaction module 410, communication module 411, and/or termination module 413, etc.) stored at memory storage module(s) 407 and/or non-transitory memory storage module(s) 412, and/or (ii) data stored at memory storage module(s) 407, at non-transitory memory storage module(s) 412, and/or in database(s) 306 (FIG. 3).

### Transaction Module 410

Under system 300, in some embodiments, the borrower can make one payment to the lender under the loan agreement and one payment to the swap provider under the interest rate swap agreement, and in other embodiments, the borrower can make a single payment to the lender or the swap provider addressing both the loan agreement and the interest rate swap agreement with the single payment. Regardless of whether the borrower makes a single payment to one of the lender or the swap provider or makes separate payments to the lender and the swap provider, as described in greater detail with respect to transaction module 410, swap provider can send a first interest payment amount to the borrower or lender and/or can receive a second interest payment amount from the borrower or lender when a current note interest rate of the loan agreement differs from a swap interest rate of the interest rate swap agreement. Where the borrower makes a single payment to the swap provider, the swap provider also can send a base payment amount to the lender determined under the swap interest rate, regardless of whether the swap provider sends the first interest payment amount or receives the second interest payment amount. The base payment amount can be equivalent to the payment the borrower would have provided directly to the lender if the borrower had made separate payments to the lender and the swap provider. In some embodiments, depending on the applicable current note rate and swap rate, the base payment amount can be nothing, in which case the swap provider would not send a base payment amount.

In many embodiments, the swap provider provides the first interest payment amount to make the lender whole under the loan agreement when an interest payment at the swap interest rate is insufficient to satisfy an interest payment amount at the current note interest rate, and the swap provider receives the second interest payment amount when the interest payment amount at the swap interest rate exceeds the interest payment amount at the current note interest rate. Receipt of the second interest payment amount can provide the incentive to the swap provider to enter into the interest rate swap agreement with the borrower. That is, the swap provider may believe that the swap provider will earn more through payments of the second interest payment amount than the swap provider will pay through payments of the first interest payment amount.

Accordingly, in many embodiments, transaction module 410 can be operable to send the first interest payment amount to the lender or to the borrower. In these embodiments, transaction module 410 can be operable to send the first interest payment amount to the lender or the borrower when a generated settlement notice comprises a notice of the first interest payment amount, as described below with respect to notification module 409. Meanwhile, in these or other embodiments, transaction module 410 can be operable to receive the second interest payment amount from the lender or to the borrower. In these embodiments, transaction module 410 can be operable to receive the second interest payment amount from the lender or the borrower when a generated settlement notice comprises a notice of the second interest payment amount, as described below with respect to notification module 409. In implementation, transaction module 410 can communicate with notification module 409 via communication module 411, as described above, to determine whether the settlement notice comprises a notice of the first interest payment amount or a notice of the second interest payment amount.

The manner of communicating the first interest payment amount to the lender and the second interest payment amount to the swap provider can be dictated by the terms of the intercreditor agreement between the lender and the swap provider and/or by the terms of the interest rate swap agreement between the borrower and the swap provider. For example, in many embodiments, transaction module 410 can send the first interest payment amount directly to the lender. Meanwhile, in these or other embodiments, transaction module 410 can receive the second interest payment amount directly from the lender. In other embodiments, transaction module 410 can send the first interest payment amount to the borrower, and the borrower can provide (i.e., pass on) the first interest payment to the borrower. Further, in these or other embodiments, the borrower can receive the second interest payment amount from the lender, and transaction module 410 can receive the second interest payment amount from the borrower. In many embodiments, implementing system 300 such that the borrower makes a single payment to the lender or the swap provider can be advantageous because it simplifies payment by the borrower, enhances the lender's relationship with the borrower, and reduces a total number of transactions between the borrower, the lender, and the swap provider.

Meanwhile, under system 300, in some examples, the swap provider can enter into a second interest rate swap agreement with a second swap provider. The first swap provider may enter into the second interest rate swap agreement with the second swap provider where the first swap provider is uncomfortable with the level of risk of the interest swap agreement with the borrower. In this manner, the first swap provider can arrange the terms of the first interest rate swap agreement and the terms of the second interest rate swap agreement such that the first swap provider can expect to make some profit from entering into the first interest rate swap agreement and the second interest rate swap agreement. The second swap provider likewise might enter into a third interest rate swap agreement with a third swap provider, and so on, until an Nth swap provider is comfortable with the level of risk involved with the interest rate swap. For example, a large commercial or investment bank may be the Nth swap provider.

Accordingly, in some embodiments, transaction module 410 can be operable to receive a third interest payment amount from a secondary swap provider and/or to send a fourth interest payment amount to the secondary swap provider. In these embodiments, the third interest payment amount can be greater than the first interest payment amount, and/or the fourth interest payment amount can be less than second interest payment amount.

Although the payments described with respect to transaction module 410 are described as occurring between the swap provider, the borrower, and/or the lender, in many embodiments, transactions between the swap provider, the borrower, and/or the lender can be performed electronically such that transactions actually occur between financial accounts (e.g., bank accounts, revolving accounts, etc.) of the swap provider, the borrower, and/or the lender. However, in other embodiments, transactions between the swap provider, the borrower, and/or the lender can be performed using tangible instruments of monetary exchange (e.g., cash, bills of exchange, etc.).

### Notification Module 409

Notification module 409 is operable to generate a settlement notice. Notification module 409 is further operable to communicate (e.g., send) the settlement notice to the borrower (e.g., via borrower computer system 303 (FIG. 3)) and/or the lender (e.g., via lender computer system 305 (FIG. 3)). In implementation, notification module 409 can communicate (e.g., send) the settlement notice to the borrower (e.g., via borrower computer system 303 (FIG. 3)) and/or the lender (e.g., via lender computer system 305 (FIG. 3)) via communication module 411, as described above. Whether notification module 409 communicates (e.g., sends) the settlement notice to the borrower (e.g., via borrower computer system 303 (FIG. 3)), to the lender (e.g., via lender computer system 305 (FIG. 3)), or to both the borrower (e.g., via borrower computer system 303 (FIG. 3)) and the lender (e.g., via lender computer system 305 (FIG. 3)) can be dictated by the terms of the intercreditor agreement between the lender and the swap provider and/or by the terms of the interest rate swap agreement between the borrower and the swap provider.

In many embodiments, the settlement notice can provide notice to the borrower and/or lender whether a first interest payment amount is due to the lender or whether a second interest payment amount is due to the swap provider, as introduced above with respect to transaction module 410. Accordingly, the settlement notice can comprise a notice of the first interest payment amount or a notice of the second interest payment amount, depending on whether a first interest payment amount or a second interest payment amount is due. In some embodiments, the settlement notice can also comprise a notice of the base payment amount introduced above with respect to transaction module 410, such as, for example, when the borrower makes a single payment to the swap provider such that the swap provider sends the base payment amount to the lender.

Notification module 409 can determine (e.g., calculate) the first interest payment amount and the second interest payment amount, as applicable. The first interest payment amount can be determined (e.g., calculated) as a difference of a current note interest rate less a swap interest rate and with reference to a current notional amount, and the second interest payment amount can be determined (e.g., calculated) as a difference of the swap interest rate less the current note interest rate and with reference to the current notional amount. In many embodiments, the current notional amount can correspond to a current principal amount of the loan made to the borrower by the lender. In these or other embodiments, when system 300 makes available a synthetic fixed interest rate to the borrower, the current note interest rate can comprise the variable interest rate of the loan agreement, and the swap interest rate can comprise the synthetic fixed interest rate resulting under the interest rate swap agreement. Meanwhile, when system 300 makes available a synthetic variable interest rate to the borrower, the current note interest rate can comprise the fixed interest rate of the loan agreement, and the swap interest rate can comprise the synthetic variable interest rate resulting under the interest rate swap agreement.

In these or other embodiments, the settlement notice can comprise the notice of the first interest payment amount when the difference of the current note interest rate less the swap interest rate is greater than zero, and the settlement notice can comprise the notice of the second interest payment amount when the difference of the swap interest rate less the current note interest rate is greater than zero. Meanwhile, in some embodiments, when the current note interest rate is equal to the swap interest rate, the settlement notice can comprise a notice indicating that no interest payment is due. In some embodiments, notification module 409 communicates (e.g., sends) the settlement notice to the borrower (e.g., via borrower computer system 303 (FIG. 3)) and/or the lender (e.g., via lender computer system 305 (FIG. 3)) when the current note interest rate is equal to the swap interest rate. In other embodiments, notification module 409 communicates (e.g., sends) no settlement notice to the borrower (e.g., via borrower computer system 303 (FIG. 3)) and/or the lender (e.g., via lender computer system 305 (FIG. 3)) when the current note interest rate is equal to the swap interest rate.

In some embodiments, when the swap provider enters into a second interest rate swap agreement with a second swap provider, notification module 409 can further generate a second settlement notice and send the second settlement notice to the second swap provider. The second settlement notice can be similar to the first settlement notice but with respect to second swap provider. For example, the second settlement notice can comprise the third interest payment amount or the fourth interest payment amount.

In many embodiments, notification module 409 can reference customer database(s) 514 in order generate and communicate (e.g., send) the settlement notice. For example, notification module 409 can reference financial database(s) 514 to determine the applicable current notice interest rate, swap interest rates under the first interest rate swap agreement and/or the second interest rate swap agreement, current principal amount, and/or current notional amount under the first interest rate swap agreement and/or the second interest rate swap agreement in order to determine the first interest payment amount, the second interest payment amount, the third interest payment amount, and/or the fourth interest payment amount, as applicable. In some embodiments, notification module 409 can reference financial database(s) 514 to determine the payment structure of the borrower, the lender, the first swap provider, and/or the second swap provider in order to generate the settlement notice. In further embodiments, when payments are made electronically under system 300, notification module 409 and/or transaction module 410 can reference financial database(s) 514 to determine account information of the borrower, the lender, the first swap provider, and/or the second swap provider, as applicable, for purposes of routing payments. Meanwhile, notification module 409 can reference contact database(s) 515 to determine contact information for the borrower, the lender, and/or the second swap provider for purposes of sending the first settlement notice and/or the second settlement notice.

### Termination Module 413

Under system 300, by way of the loan documents and the interest rate swap agreement (e.g., the rate protection agreement), the borrower can provide to the swap provider a shared security interest (e.g., lien) in part or all of the collateral securing the loan under the loan agreement. Advantageously, because the borrower can pledge the same collateral for the interest rate swap agreement as for the loan agreement, the borrower does not need to pledge multiple sources of collateral, which in many examples, the borrower may not have available. Meanwhile, although the collateral securing the interest rate swap agreement can comprise any suitable form of collateral (e.g., cash, securities, etc.), in many embodiments, the collateral can comprise real property (e.g., a commercial property or other assets) of the borrower. The ability to pledge real property for the interest rate swap agreement can be advantageous because the borrower may not have other forms of collateral available to pledge and real property of the borrower may be the only form of collateral owned by the borrower having material value sufficient to pledge as collateral.

Further under system 300, by way of the intercreditor agreement between the lender and the swap provider (e.g., the servicing and intercreditor agreement), the lender can provide to the swap provider a priority right of recovery in the collateral securing the loan up to a swap cap amount. The swap cap amount can relate to a swap termination fee amount (e.g., a variable swap termination fee amount) that may become due by the borrower under the interest rate swap agreement. For example, the swap termination fee amount may become due by the borrower under the interest rate swap agreement when (i) the borrower prepays at least part of the current principal amount of the loan, (ii) the borrower at least partially terminates the loan, (iii) the borrower at least partially terminates the interest rate swap, (iv) the borrower defaults on the loan, (v) the borrower defaults on the interest rate swap, etc. The swap termination fee amount can help to make the swap provider at least partially whole in the event that the swap provider would not otherwise receive ongoing payments under the interest rate swap agreement. Advantageously, the swap termination fee amount is not a legally prohibited fee within a legal jurisdiction in which the loan is made and in which the interest rate swap is entered, such as, for example, within the legal jurisdiction of the United States of America. For example, the swap termination fee amount is not a prepayment penalty or other legally prohibited fee.

As provided above, in many examples, the swap termination fee amount can comprise a variable swap termination fee amount. That is, the variable swap termination fee amount can differ depending on the circumstances under which the variable swap termination fee amount becomes due. In some examples, when one or more of a first set of circumstances (e.g., the borrower prepays at least part of the current principal amount of the loan, the borrower at least partially terminates the interest rate swap agreement, etc.), the variable swap termination fee amount can comprise a full amount due under the interest rate swap agreement. Meanwhile, when one or more of a second set of circumstances (e.g., the borrower defaults on the loan, the borrower defaults on the interest rate swap, etc.) occurs, the variable swap termination fee can become due to the swap provider in stages. First, the variable swap termination fee amount can comprise at least part of the swap cap amount. Then, when the variable swap termination fee amount comprises all of the swap cap amount, and after all loan obligations to the lender under the loan agreement have been satisfied, the variable swap termination fee can comprise at least part of or all of a difference of the full amount due under the interest rate swap less the swap cap amount. Regardless of the manner in which the variable swap termination fee amount becomes due to the swap provider, to the extent that the variable swap termination fee is paid using at least part of any collateral and/or using at least part of any proceeds obtained from selling the collateral, if any of the collateral and/or any proceeds obtained from selling the collateral remain after the full amount due under the interest rate swap is paid in full to the swap provider and after the all loan obligations to the lender under the loan agreement have been satisfied, the remaining collateral and/or proceeds obtained from selling the collateral can be provided to the borrower.

Advantageously, in many examples, setting the swap cap amount can ensure the swap provider receives at least part of a full amount due under the interest rate swap agreement without running afoul of legal restrictions on the LTV ratio of the collateral to the loan. For example, because the lender provides to the swap provider the priority right of recovery in the collateral securing the loan up to the swap cap amount, the swap provider is able to recover at least part of the swap cap amount before the lender can recover from the borrower any obligations of the borrower under the loan. However, the swap cap amount can be restricted so that an aggregate amount of an initial principal amount of the loan and the swap cap amount is less than a predetermined percentage of a value of the collateral.

Accordingly, in many embodiments, termination module 413 can be operable to determine (e.g., calculate) the swap cap amount such that the aggregate amount of the initial principal amount of the loan and the swap cap amount is less than a predetermined percentage (e.g., 70 percent, 75 percent, 80 percent, 85 percent, 90 percent, etc.) of a value of the collateral. Further, in these or other embodiments, termination module 413 can be operable to determine (e.g., calculate) the swap cap amount such that the aggregate amount of the initial principal amount of the loan and the swap cap amount is less than the predetermined percentage while being as close to the predetermined percentage as possible within a predetermined level of certainty. Determining the swap cap amount to be as close to the predetermined percentage as possible within the predetermined percentage can maximize the amount that can be recovered under the swap cap amount.

The predetermined percentage can be any suitable percentage. However, in some embodiments, the predetermined percentage can be dictated by law. Accordingly, in these or other embodiments, termination module 413 can ensure the aggregate amount of the initial principal amount of the loan and the swap cap amount does not exceed an amount that would violate a legally permitted LTV ratio of the collateral. Likewise, when the shared security interest in the collateral securing the loan is received by the swap provider, and when the collateral is securing the loan under the loan agreement, an amount of the collateral can comply with an LTV ratio restriction within a legal jurisdiction in which the loan is made and in which the interest rate swap is entered, such as, for example, within the legal jurisdiction of the United States of America.

Meanwhile, the predetermined level of certainty can be any suitable percentage. However, in many embodiments, the predetermined level of certainty can be established by the lender or the swap provider.

In these or other embodiments, termination module 413 can determine (e.g., calculate) the swap cap amount with a probabilistic algorithm. In some embodiments, the probabilistic algorithm can comprise a value at risk algorithm, such as, for example, a Monte Carlo simulation. In many embodiments, it can be desirable that the swap cap amount can be calculated quickly and/or with a high level of accuracy. For example, a swap provider may need to know the swap cap amount within minutes, hours, or days to make a decision on closing on an interest rate swap agreement with the borrower and/or an intercreditor agreement with the lender. Otherwise, a swap provider may not have the knowledge needed to determine whether entering into an interest rate swap agreement is a good bet, and/or a borrower may move on to an alternative option. Accordingly, in many embodiments, termination module 413 can determine (e.g., calculate) the swap cap amount in less than one or more minutes, one or more hours, or one or more days. Meanwhile, a swap provider may need to be able to determine (e.g., calculate) the swap cap amount with very high accuracy, while doing so in a short period of time, to give a lender calm that the intercreditor agreement and interest rate swap agreement will not violate any laws or regulations that would cause the lender to incur fines. For example, in some embodiments, a lender may require the swap provider to be able to determine that the swap cap amount does not exceed the predetermined percentage with a level or certainty greater than or equal to approximately 99 percent, 99.9 percent, 99.99 percent, or 99.999 percent. For at least these reasons, in many embodiments, implementing the functionality of termination module 413 manually (i.e., without computer software and/or hardware) may be impracticable or even impossible.

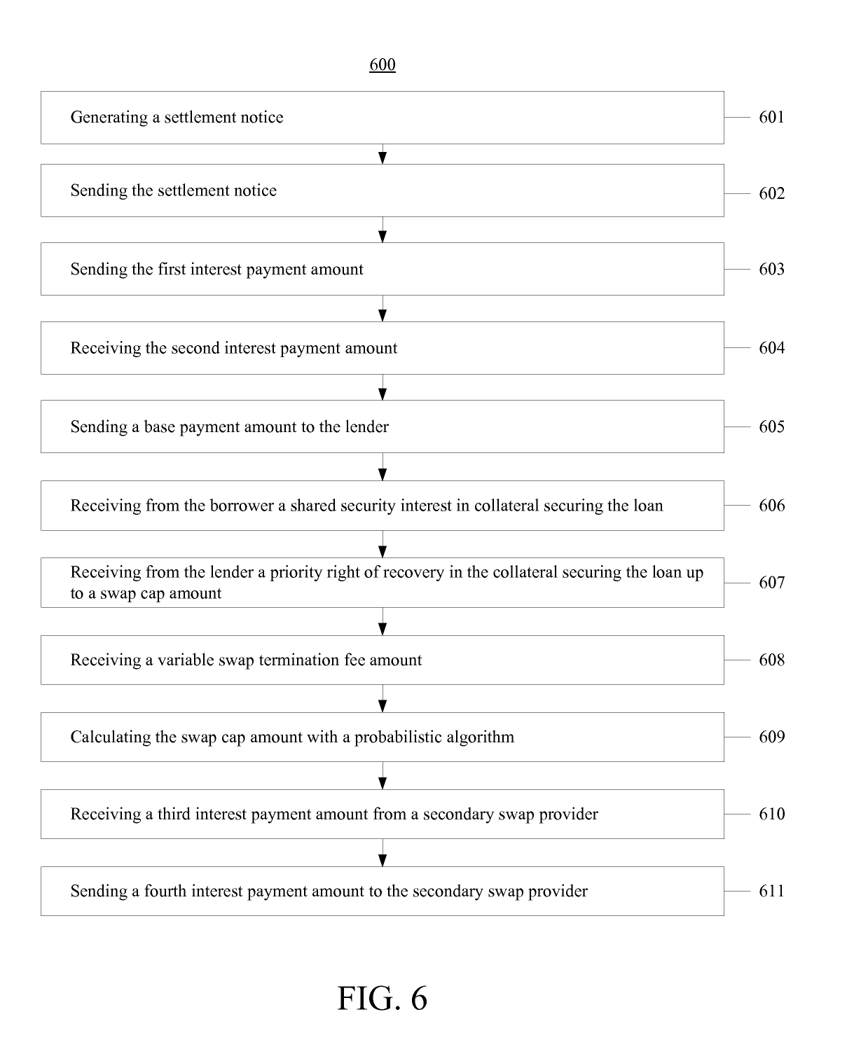

Turning ahead in the drawings, FIG. 6 illustrates a flow chart for a method 600, according to an embodiment. Method 600 is merely exemplary and is not limited to the embodiments presented herein. Method 600 can be employed in many different embodiments or examples not specifically depicted or described herein. In some embodiments, the activities of method 600 can be performed in the order presented. In other embodiments, the activities of method 600 can be performed in any suitable order. In still other embodiments, one or more of the activities of method 600 can be combined or skipped. In many embodiments, central computer system 301 (FIG. 3) can be suitable to perform method 600 and/or one or more of the activities of method 600. In these or other embodiments, one or more of the activities of method 600 can be implemented as one or more computer instructions configured to run at one or more processing modules and configured to be stored at one or more non-transitory memory storage modules. The processing module(s) can be similar or identical to the processing module(s) described above with respect to computer system 100 (FIG. 1) and/or to processing module(s) 407 (FIG. 4). Further, the non-transitory memory storage module(s) can be similar or identical to the non-transitory memory storage module(s) described above with respect to computer system 100 (FIG. 1) and/or to non-transitory memory storage module(s) 412 (FIG. 4).

In some embodiments, method 600 can comprise a method of making available a synthetic fixed interest rate to a borrower under a loan and a variable interest rate to a lender of the loan; and in other embodiments, method 600 can comprise a method of making available a synthetic variable interest rate to a borrower under a loan and a fixed interest rate to a lender of the loan. In these or other embodiments, the borrower can be similar or identical to the borrower described above with respect to system 300 (FIG. 3); the lender can be similar or identical to the lender described above with respect to system 300 (FIG. 3); and/or the loan can be similar or identical to the loan described above with respect to system 300 (FIG. 3). Meanwhile, when applicable, the synthetic fixed interest rate can be similar to the synthetic fixed interest rate described above with respect to system 300 (FIG. 3); the synthetic variable interest rate can be similar to the synthetic variable interest rate described above with respect to system 300 (FIG. 3); the fixed interest rate can be similar or identical to the fixed interest rate described above with respect to system 300 (FIG. 3); and/or the variable interest rate can be similar or identical to the variable interest rate described above with respect to system 300 (FIG. 3). In these or other embodiments, method 600 can transform a synthetic fixed interest rate made available to a borrower under a loan into a variable interest rate due to a lender of the loan, and vice versa; and/or method 600 can transform a synthetic variable interest rate made available to a borrower under a loan to a fixed interest rate due to a lender of the loan, and vice versa.

In many embodiments, method 600 can comprise activity 601 of generating a settlement notice. The settlement notice can be similar or identical to the settlement notice described above with respect to system 300 (FIG. 3).

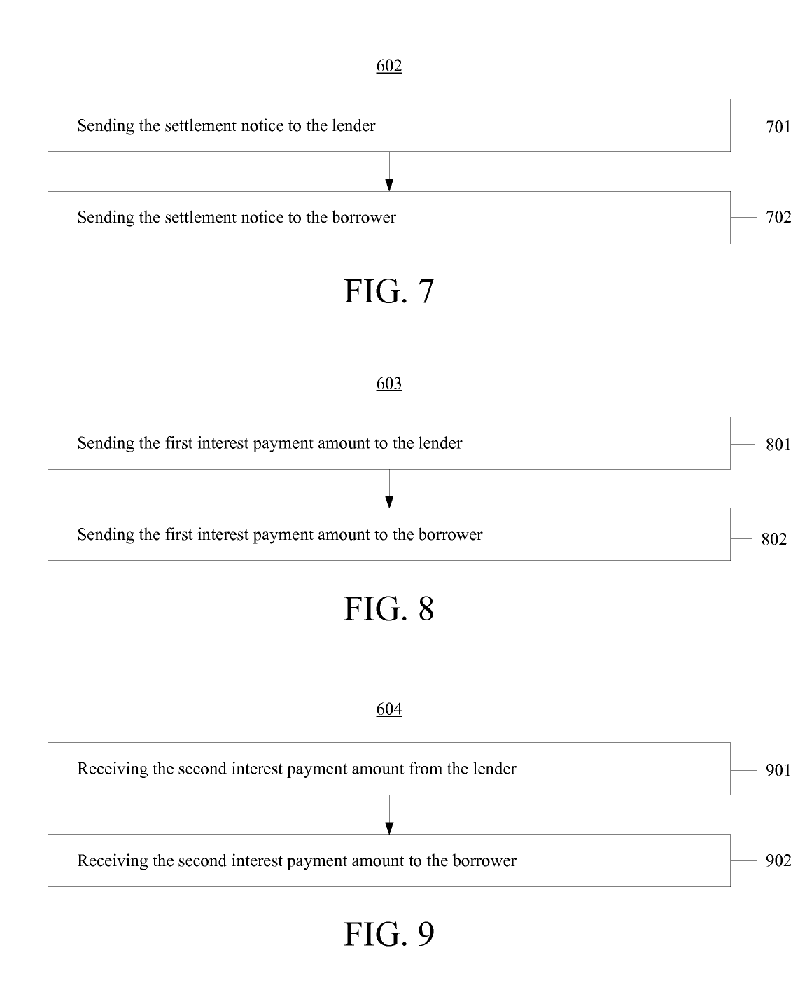

In many embodiments, method 600 can comprise activity 602 of sending the settlement notice. In some embodiments, performing activity 602 can be similar or identical to sending the settlement notice as described above with respect to system 300 (FIG. 3). FIG. 7 illustrates an exemplary activity 602, according to the embodiment of FIG. 6.

In some embodiments, as shown in FIG. 7, activity 602 can comprise activity 701 of sending the settlement notice to the lender. In these or other embodiments, activity 602 can comprise activity 702 of sending the settlement notice to the borrower. In some embodiments, when activity 701 is performed activity 702 can be omitted, or vice versa.

Returning to FIG. 6, in many embodiments, method 600 can comprise activity 603 of sending the first interest payment amount. For example, method 600 can comprise activity 603 when the settlement notice comprises a notice of a first interest payment amount. In some embodiments, performing activity 603 can be similar or identical to sending the first interest payment amount as described above with respect to system 300 (FIG. 3). Further, the first interest payment amount can be similar or identical to the first interest payment amount described above with respect to system 300 (FIG. 3). FIG. 8 illustrates an exemplary activity 603, according to the embodiment of FIG. 6.

In some embodiments, as shown in FIG. 8, activity 603 can comprise activity 801 of sending the first interest payment amount to the lender. In other embodiments, activity 603 can comprise activity 802 of sending the first interest payment amount to the borrower. In some embodiments, when activity 801 is performed activity 802 can be omitted, or vice versa.

Returning to FIG. 6, in many embodiments, method 600 can comprise activity 604 of receiving the second interest payment amount. For example, method 600 can comprise activity 604 when the settlement notice comprises a notice of a second interest payment amount. In some embodiments, performing activity 604 can be similar or identical to receiving the second interest payment amount as described above with respect to system 300 (FIG. 3). Further, the second interest payment amount can be similar or identical to the second interest payment amount described above with respect to system 300 (FIG. 3). In some embodiments, when activity 603 is performed, activity 604 can be omitted, or vice versa. FIG. 9 illustrates an exemplary activity 604, according to the embodiment of FIG. 6.

In some embodiments, as shown in FIG. 9, activity 604 can comprise activity 901 of receiving the second interest payment amount from the lender. In other embodiments, activity 604 can comprise activity 902 of receiving the second interest payment amount to the borrower. In some embodiments, when activity 901 is performed activity 902 can be omitted, or vice versa.

Referring back to FIG. 6, in some embodiments, method 600 can comprise activity 605 of sending a base payment amount to the lender. In some embodiments, performing activity 605 can be similar or identical to sending the base payment amount to the lender as described above with respect to system 300 (FIG. 3). Further, the base payment amount can be similar or identical to the base payment amount described above with respect to system 300 (FIG. 3). In some embodiments, activity 605 can be omitted.

In some embodiments, method 600 can comprise activity 606 of receiving from the borrower a shared security interest in collateral securing the loan. In many embodiments, performing activity 606 can be similar or identical to receiving from the borrower the shared security interest in collateral securing the loan as described above with respect to system 300 (FIG. 3). Further, the shared security interest can be similar or identical to the shared security interest described above with respect to system 300 (FIG. 3); and/or the collateral can be similar or identical to the collateral described above with respect to system 300 (FIG. 3).

Further, method 600 can comprise activity 607 of receiving from the lender a priority right of recovery in the collateral securing the loan up to a swap cap amount. In many embodiments, performing activity 607 can be similar or identical to receiving from the lender the priority right of recovery in the collateral securing the loan up to the swap cap amount as described above with respect to system 300 (FIG. 3). Further, the priority right of recovery can be similar or identical to the priority right of recovery described above with respect to system 300 (FIG. 3); and/or the swap cap amount can be similar or identical to the swap cap amount described above with respect to system 300 (FIG. 3).

In some embodiments, method 600 can comprise activity 608 of receiving a variable swap termination fee amount. In many embodiments, performing activity 608 can be similar or identical to receiving the variable swap termination fee amount as described above with respect to system 300 (FIG. 3). Further, the variable swap termination fee amount can be similar or identical to the variable swap termination fee amount described above with respect to system 300 (FIG. 3). In some embodiments, activity 608 can be omitted. In some embodiments, activity 608 can be performed after one or more of activities 601-607 and 609-611.

In some embodiments, method 600 can comprise activity 609 of calculating the swap cap amount with a probabilistic algorithm. In many embodiments, performing activity 609 can be similar or identical to calculating the swap cap amount with the probabilistic algorithm as described above with respect to system 300 (FIG. 3). Further, the probabilistic algorithm can be similar or identical to the probabilistic algorithm described above with respect to system 300 (FIG. 3). In some embodiments, activity 606, activity 607, and/or activity 609 can be performed before one or more of activities 601-605, 608, 610, and 611.

In some embodiments, method 600 can comprise activity 610 of receiving a third interest payment amount from a secondary swap provider. In many embodiments, performing activity 610 can be similar or identical to receiving the third interest payment amount from the secondary swap provider as described above with respect to system 300 (FIG. 3). Further, the third interest payment amount can be similar or identical to the third interest payment amount described above with respect to system 300 (FIG. 3); and/or the secondary swap provider can be similar or identical to the secondary swap provider as described above with respect to system 300 (FIG. 3). In some embodiments, activity 610 can be omitted, such as, for example, when activity 611 is performed.

In some embodiments, method 600 can comprise activity 611 of sending a fourth interest payment amount to the secondary swap provider. In many embodiments, performing activity 611 can be similar or identical to sending the fourth interest payment amount to the secondary swap provider as described above with respect to system 300 (FIG. 3). Further, the fourth interest payment amount can be similar or identical to the fourth interest payment amount described above with respect to system 300 (FIG. 3). In some embodiments, activity 611 can be omitted, such as, for example, when activity 610 is performed.

In many embodiments, one or more of activities 601-605, 610, and 611 can be repeated one or more times. For example, in some embodiments, one or more of activities 601-605, 610, and 611 can be repeated at a regular interval (e.g., weekly, monthly, quarterly, semiannually, annually, etc.).

Having provided the above description of system 300 (FIG. 3) and method 600 (FIG. 6), other embodiments of systems and methods are also provided herein. Some embodiments can include systems similar to system 300 (FIG. 3) and/or methods similar to method 600 (FIG. 6). Some of these systems and methods can be centric to a borrower computer system and/or a borrower (e.g., operating the borrower computer system). The borrower computer system can be similar or identical to borrower computer system 303 (FIG. 3) and/or the borrower can be similar or identical to the borrower described above with respect to system 300 (FIG. 3). Meanwhile, other of these systems and methods can be centric to a lender computer system and/or a lender (e.g., operating the lender computer system). The lender computer system can be similar or identical to lender computer system 305 (FIG. 3) and/or the lender can be similar or identical to the borrower described above with respect to system 300 (FIG. 3).

Although extending an existing product taxonomy has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-9 may be modified, and that the foregoing discussion of certain of these embodiments does not necessarily represent a complete description of all possible embodiments. For example, one or more of the activities of method 600 (FIG. 6) or one or more of the other methods described herein may include different activities and be performed by many different modules, in many different orders. As another example, the modules within central computer system 301, borrower computer system(s) 302, and/or lender computer system(s) 304 in FIG. 3 can be interchanged or otherwise modified.

Generally, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A method of making available a synthetic fixed interest rate to a borrower under a loan and a variable interest rate to a lender of the loan, the method comprising:
executing one or more first computer instructions configured to generate a settlement notice, the settlement notice comprising one of a notice of a first interest payment amount or a notice of a second interest payment amount;
executing one or more second computer instructions configured to send the settlement notice;
when the settlement notice comprises the notice of the first interest payment amount, sending the first interest payment amount;
when the settlement notice comprises the notice of the second interest payment amount, receiving the second interest payment amount; and
receiving from the borrower a shared security interest in collateral securing the loan, the shared security interest being shared with the lender;
wherein:
the loan comprises a variable rate loan, and the loan is made by the lender to the borrower;
the variable interest rate on the loan is synthetically fixed by entering into an interest rate swap;
the first interest payment amount is calculated with reference to a difference of a current note interest rate less a swap interest rate and with reference to a current notional amount corresponding to a current principal amount of the loan;
the second interest payment amount is calculated with reference to a difference of the swap interest rate less the current note interest rate and with reference to the current notional amount;
the current note interest rate comprises the variable interest rate of the loan;
the swap interest rate comprises the synthetic fixed interest rate;
the lender comprises a credit union lender;
the settlement notice comprises the notice of the first interest payment amount when the difference of the current note interest rate less the swap interest rate is greater than zero;
the settlement notice comprises the notice of the second interest payment amount when the difference of the swap interest rate less the current note interest rate is greater than zero; and
the one or more first computer instructions and the one or more second computer instructions are configured to run at one or more processing modules and configured to be stored at one or more non-transitory memory storage modules.

2) The method of claim 1 wherein:
executing the one or more second computer instructions configured to send the settlement notice comprises executing one or more third computer instructions configured to send the settlement notice to the lender.

3) The method of claim 1 wherein:
executing the one or more second computer instructions configured to send the settlement notice comprises executing one or more third computer instructions configured to send the settlement notice to the borrower.

4) The method of claim 1 wherein:
sending the first interest payment amount comprises sending the first interest payment amount to the lender; and
receiving the second interest payment amount comprises receiving the second interest payment amount from the lender.

5) The method of claim 1 wherein:
sending the first interest payment amount comprises sending the first interest payment amount to the borrower; and
receiving the second interest payment amount comprises receiving the second interest payment amount from the borrower.

6) The method of claim 1 wherein:
the collateral comprises real property of the borrower.

7) The method of claim 1 further comprising:
receiving a variable swap termination fee amount;
wherein:
when the borrower (i) prepays at least part of the current principal amount of the loan, (ii) at least partially terminates the interest rate swap, or (iii) at least partially terminates the loan, the variable swap termination fee amount comprises a full amount due under the interest rate swap.

8) The method of claim 1 further comprising:
receiving from the lender a priority right of recovery in the collateral securing the loan up to a swap cap amount, the swap cap amount being less than a full amount due under the interest rate swap; and
receiving a variable swap termination fee amount;
wherein:
when the borrower defaults on the loan or the interest rate swap, the variable swap termination fee amount comprises the swap cap amount.

9) The method of claim 8 further comprising:
after all loan obligations from the borrower to the lender under the loan have been satisfied, receiving at least part of a difference of the full amount due under the interest rate swap less the swap cap amount, the variable swap termination fee amount further comprising the at least part of the difference of the full amount due under the interest rate swap less the swap cap amount.

10) The method of claim 1 further comprising:
when at least one of (i) the borrower prepays at least part of the current principal amount, (ii) the borrower at least partially terminates the loan, (iii) the borrower at least partially terminates the interest rate swap, (iv) the borrower defaults on the loan, (v) the borrower defaults on the interest rate swap, or (vi) the borrower becomes obligated to pay a variable swap termination fee amount, receiving the variable swap termination fee amount;
wherein:
the variable swap termination fee amount is not a legally prohibited fee within a legal jurisdiction in which the loan is made and in which the interest rate swap is entered.

11) The method of claim 1 further comprising:
receiving from the lender a priority right of recovery in the collateral securing the loan up to a swap cap amount, the swap cap amount being less than a full amount due under the interest rate swap; and
executing one or more third computer instructions configured to calculate the swap cap amount with a probabilistic algorithm;
wherein:
the one or more third computer instructions are configured to run at one or more processing modules and configured to be stored at one or more non-transitory memory storage modules.

12) The method of claim 11 wherein:
executing the one or more third computer instructions comprises executing one or more fourth computer instructions configured to calculate the swap cap amount with a value at risk algorithm, the probabilistic algorithm comprising the value at risk algorithm.

13) The method of claim 11 wherein:
an aggregate amount of an initial principal amount of the loan and the swap cap amount is less than a predetermined percentage of a value of the collateral.

14) The method of claim 1 wherein:
a term of the interest rate swap is equal to a term of the loan.

15) The method of claim 1 further comprising at least one of:
receiving a third interest payment amount from a secondary swap provider; or
sending a fourth interest payment amount to the secondary swap provider.

16) The method of claim 1 wherein:
the borrower is able to make a single payment for each payment period of the loan and the interest rate swap, the single payment addressing both the loan and the interest rate swap.

17) The method of claim 1 wherein at least one of:
with respect to the loan, the lender is not exercising derivatives authority within a legal jurisdiction in which the loan is made and in which the interest rate swap is entered; or
when the shared security interest in the collateral securing the loan is received, and when the collateral is securing the loan, an amount of the collateral complies with a loan-to-value restriction within the legal jurisdiction in which the loan is made and in which the interest rate swap is entered.

18) A system operable to make available a synthetic fixed interest rate to a borrower under a loan and a variable interest rate to a lender of the loan, the system comprising:
an input device;
a display device;
one or more processing modules; and
one or more non-transitory memory storage modules storing computer instructions configured to run on the one or more processing modules and perform the acts of:
generating a settlement notice, the settlement notice comprising one of a notice of a first interest payment amount or a notice of a second interest payment amount;
sending the settlement notice;
when the settlement notice comprises the notice of the first interest payment amount, sending the first interest payment amount; and
when the settlement notice comprises the notice of the second interest payment amount, receiving the second interest payment amount;
wherein:
an operator of the system and the lender hold a shared security interest in at least part of collateral securing the loan;
the loan comprises a variable rate loan, and the loan is made by the lender to the borrower;
the variable interest rate on the loan is synthetically fixed by entering into an interest rate swap;
the first interest payment amount is calculated with reference to a difference of a current note interest rate less a swap interest rate and with reference to a current notional amount corresponding to a current principal amount of the loan;
the second interest payment amount is calculated with reference to a difference of the swap interest rate less the current note interest rate and with reference to the current notional amount;
the current note interest rate comprises the variable interest rate of the loan;
the swap interest rate comprises the synthetic fixed interest rate;
the lender comprises a credit union lender;
the settlement notice comprises the notice of the first interest payment amount when the difference of the current note interest rate less the swap interest rate is greater than zero;
the settlement notice comprises the notice of the second interest payment amount when the difference of the swap interest rate less the current note interest rate is greater than zero; and
the input device and the display device are configured to permit the operator to manage the one or more processing modules and the one or more non-transitory memory storage modules.

19) The system of claim 18 wherein one of:
the computer instructions are further configured to perform the act of sending the settlement notice to the lender, and sending the settlement notice comprises sending the settlement notice to the lender; or
the computer instructions are further configured to perform the act of sending the settlement notice to the borrower, and sending the settlement notice comprises sending the settlement notice to the borrower.

20) The system of claim 18 wherein at least one of:
sending the first interest payment amount comprises the sending the first interest payment amount to the lender;
sending the first interest payment amount comprises the sending the first interest payment amount to the borrower;
receiving the second interest payment amount comprises the receiving the second interest payment amount from the lender; or
receiving the second interest payment amount comprises the receiving the second interest payment amount from the borrower.

21) The system of claim 18 wherein:
the at least part of the collateral comprises real property of the borrower.

22) The system of claim 18 wherein
the computer instructions are further configured to calculate a swap cap amount; and
the operator has received from the lender a priority right of recovery from the at least part of the collateral securing the loan up to the swap cap amount, the swap cap amount being less than a full amount due under the interest rate swap;
wherein:
an aggregate amount of an initial principal amount of the loan and a variable swap termination fee amount is less than a predetermined percentage of a value of the at least part of the collateral.

23) A method of making available a synthetic fixed interest rate to a borrower under a loan while receiving a variable interest rate under the loan as a credit union lender, the method comprising:
making a loan to the borrower;
granting to a swap provider a priority right of recovery in collateral securing the loan;
executing one or more first computer instructions configured to receive a settlement notice from the swap provider, the settlement notice comprising one of a notice of a first interest payment amount or a notice of a second interest payment amount; and
executing one or more second computer instructions configured to transform the variable interest rate to the synthetic fixed interest rate made available to the borrower, the executing the one or more second computer instructions comprising:
when the settlement notice comprises the notice of the first interest payment amount:
executing one or more third computer instructions configured to receive the first payment amount from the swap provider;
and
when the settlement notice comprises the notice of the second interest payment amount:
executing one or more fourth computer instructions configured to send the second interest payment amount to the swap provider;
wherein:
the borrower receives the synthetic fixed interest rate by entering into an interest rate swap with the swap provider;
the first interest payment amount is calculated with reference to a difference of a current note interest rate less a swap interest rate and with reference to a current notional amount corresponding to a current principal amount of the loan;
the second interest payment amount is calculated with reference to a difference of the swap interest rate less the current note interest rate and with reference to the current notional amount;
the current note interest rate comprises the variable interest rate;
the swap interest rate comprises the synthetic fixed interest rate;
the settlement notice comprises the notice of the first interest payment amount when the difference of the current note interest rate less the swap interest rate is greater than zero;
the settlement notice comprises the notice of the second interest payment amount when the difference of the swap interest rate less the current note interest rate is greater than zero; and
the one or more first computer instructions, the one or more second computer instructions, the one or more third computer instructions, and the one or more fourth computer instructions are configured to run at one or more processing modules and configured to be stored at one or more non-transitory memory storage modules.
